(19) United States
(12) Patent Application Publication
(10) Pub. No.: US 2020/0320141 A1
(43) Pub. Date: Oct. 8, 2020

(54) RECORD REPORTING SYSTEM

(71) Applicant: Arcuity ai, Inc., Escondido, CA (US)

(72) Inventor: John J. Salvati, Rancho Cucamonga, CA (US)

(21) Appl. No.: 16/840,307

(22) Filed: Apr. 3, 2020

Related U.S. Application Data
(60) Provisional application No. 62/867,190, filed on Jun. 26, 2019.
(60) Provisional application No. 62/829,522, filed on Apr. 4, 2019.

(51) Int. Cl. G06F 16/903; G06F 16/93; G06F 16/904

(52) U.S. Cl. CPC G06F 16/90335; G06F 16/904; G06F 16/94

(57) ABSTRACT

A system for reporting record data may include generating a summary report based on a set of records. The summary report includes a plurality of entries with data representative of the set of records, and the summary report is displayed in a first user interface. A second user interface is generated that is configured to display a search result based on a query, the search result including data associated with the plurality of entries. An entry from among the plurality of entries associated with data corresponding to the selected search result is displayed at the first user interface in response to a user selection of the search result at the second user interface. The data corresponding to the selected search result is highlighted at the first interface in response to the user selection of the search result at the second user interface.

### CROSS-REFERENCE TO RELATED APPLICATIONS

This application claims priority to U.S. Provisional Application No. 62/829,522, filed on Apr. 4, 2019, and titled “SELF AUTHENTICATING RECORDS AND DOCUMENTS,” and U.S. Provisional Application No. 62/867,190, filed on Jun. 26, 2019, and titled “SECURE AUTHENTICATION AND PERMISSIONED SHARING OF RECORDS,” the entirety of each of which is incorporated by reference herein.

### TECHNICAL FIELD

The subject matter described herein relates generally to document processing and presentation and, more specifically, to a computer-implemented record reporting system.

### BACKGROUND

Large sets of data records are exchanged among various entities, such as legal, medical, and governmental organizations on a daily and even hourly basis. Most organizations have to dedicate vast amounts of computing resources to verify the exchanged data records and identify the relevant information. Moreover, once the relevant information is identified, determining the source of information at a later time may be difficult and require additional computing resources.

Records combined together from a variety of sources generally lack organization. With records arriving in different formats, the combined set of records typically lack cover pages, tables of content, hyperlinks, or summaries. Even when records arrive in the same format, the file size may be extremely large and overwhelm computing devices. Moreover, the vast amount of information presents obstacles in locating and identifying pertinent information.

### SUMMARY

Systems, methods, and articles of manufacture, including computer program items, are provided for a record reporting system. In one aspect, a system includes at least one data processor and at least one memory. The at least one memory stores instructions that cause operations when executed by the at least one data processor. The operations include generating a summary report based on a set of records. The summary report includes a plurality of entries with data representative of the set of records, and the summary report is displayed in a first user interface. A second user interface is generated that is configured to display a search result based on a query, the search result including data associated with the plurality of entries. An entry from among the plurality of entries associated with data corresponding to the selected search result is displayed at the first user interface in response to a user selection of the search result at the second user interface. The data corresponding to the selected search result is highlighted at the first interface in response to the user selection of the search result at the second user interface.

In some variations, one or more features disclosed herein including the following features can optionally be included in any feasible combination. In some variations, the generating the summary report includes generating a hyperlink for each of at least two entries of the plurality of entries, the hyperlink connecting each of the at least two entries of the plurality of entries to each of at least two corresponding records of the set of records, the hyperlink configured to instruct the first user interface to display each of the at least two corresponding records connected to the at least two entries of the plurality of entries.

In some variations, generating the summary report includes generating an additional hyperlink for each of at least two records of the set of records, the additional hyperlink connecting each of the at least two records of the set of records to each of at least two corresponding entries of the plurality of entries, the additional hyperlink configured to instruct the first user interface to display each of the at least two corresponding entries connected to the at least two records of the set of records.

In some variations, generating the summary report further comprises storing text from an optical character recognition of the set of records into a Java Script Object Notification (JSON) file, the summary report generated based on the data stored in the JSON file.

In some variations, a cognitive search algorithm performs the query, the query being based on the JSON file, the cognitive search algorithm configured to return similar words and phrases as a keyword for conducting the query.

In some variations, the first user interface and the second user interface are generated based on the JSON file.

In some variations, wherein the search result includes a narrative from the summary report.

In some variations, the system comprises displaying an additional entry of the plurality of entries associated with additional data corresponding to the additional search result at the first user interface in response to an additional user selection of an additional search result at the second user interface; and in response to the additional user selection of the additional search result at the second user interface, highlighting the additional data corresponding to the additional search result displayed at the first user interface.

In some variations, generating the summary report includes generating an annotation interface including comments, the annotation interface connected to the entry of the plurality of entries by a hyperlink, the hyperlink configured to instruct the first user interface to display the comments connected to the entry of the plurality of entries.

In some variations, wherein in response to selecting the hyperlink, the comments connected to the entry of the plurality of entries are highlighted.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to internal tables for accessing data stored in a database, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a user interface illustrating a record reporting system, in accordance with some example embodiments;

FIG. 2 depicts a user interface illustrating a record report associated with a record, in accordance with some example embodiments;

FIG. 3 depicts a user interface illustrating a table of contents hyperlinked to a record report, in accordance with some example embodiments;

FIG. 4 depicts a user interface illustrating an annotation interface hyperlinked to the record report, in accordance with some example embodiments;

FIG. 5 depicts a flowchart illustrating a process for generating a user interface configured to display and highlight data corresponding to a search result, in accordance with some example embodiments; and

FIG. 6 depicts a block diagram illustrating a computing system, in accordance with some example embodiments.

When practical, similar reference numbers denote similar structures, features, or elements.

### DETAILED DESCRIPTION OF EXAMPLE EMBODIMENTS

Businesses, including those in the legal, medical, and government industries, examine hundreds of pages using a word query mechanism to find relevant information in records. The records themselves may lack organization as a result of being combined together from a variety of sources. With records arriving in different formats, the combined set of records typically lack cover pages, tables of content, hyperlinks, summaries, and/or the like. Even when records arrive in the same format, the file size may be extremely large and overwhelm computing devices. Moreover, the vast amount of information presents obstacles in locating and identifying pertinent information.

The proposed record reporting system disclosed herein provides a solution by at least one of organizing large files, organizing complicated information, generating hyperlinks, enabling smarter searches, or providing multiple interfaces for easy presentation. The record reporting system may enable users to identify complicated concepts across the set of records by generating summary tables. The record reporting system may enable the user to search, highlight, annotate, and export the summary tables. Hyperlinking across the record reporting system enables the user interface to quickly identify and present important information. A cognitive search algorithm may identify complicated topics across all records instead of, or in addition to, searching across one document or one keyword, at a time.

The record reporting system may generate summaries of a set of records compiled together in a summary report using an AI-enhanced search algorithm. The record reporting system may include a cognitive search engine capable of identifying salient information within the summaries. The record reporting system may generate a user interface hyperlinking the search results to the summaries representative of the set of records. The record reporting system may generate a user interface hyperlinking the summaries to the set of records and the set of records to the summaries. The record reporting system may generate one or more hyperlinked tables of content corresponding to the summaries. A cognitive search engine may carry out queries of information located within the summaries of the records. The record reporting system may generate a user interface including an annotation window from which a user can annotate and store notes regarding the summaries and the records.

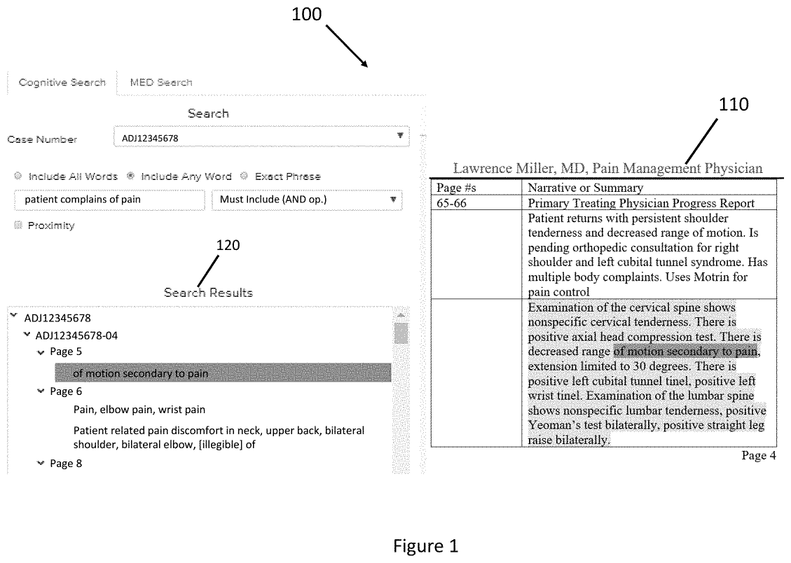

FIG. 1 depicts a user interface illustrating a record reporting system, in accordance with some example embodiments. The record reporting system 100 may include a summary table 110 and a search result interface 120. The record reporting system 100 may include the summary table 110 and the search result interface 120 in a single user interface or in multiple user interfaces.

The record reporting system 100 includes a summary table 110 including important information gathered from a record of a set of records. The record reporting system 100 may generate one or more summary tables based on the set of records using a cognitive search engine. The summary table 110 may be a verbatim summary of a record from the set of records. For example, the summary table 110 may include a table of rows and columns representing pertinent information of the record. The summary table 110 may include data corresponding to a single record in the set of records. The summary table 110 may include information representative of the record of the set of records including page numbers, locations, administrators, important persons, summaries of facts, summaries of events, and summaries of observations. The summary table 110 may include a narrative or summary that is a synopsis of a record from a set of records.

The summary table 110 may include various header tabs for organizing a table of information underneath. These header tabs of information may be hyperlinked to a table of contents. An example summary may include a header, a page number where a full record of the summary may be found, the relevant dates the record was created, and the data representative of observations. Information representative of the record may be organized within the rows and columns of the summary table 110.

The summary table 110 may pull information verbatim from the set of records. Alternatively, and/or additionally, the cognitive search engine may interpret the information provided by the set of records and create a record that rephrases complex concepts to succinct descriptions. Alternatively, and/or additionally, the summary table 110 may be generated by an AI-enhanced algorithm that extracts the most relevant portions from the record and condenses information contained within the record. The cognitive search engine may identify information in a first set of records that is relevant in multiple summaries and incorporate the information into the various summaries.

The search results interface 120 may display the search results of the cognitive search engine. The search results interface 120 may display search results identifying relevant information in the summary table 110 based on a query. Additionally, the search results interface 120 may be configured to display pertinent information of interest in the summary table 110 based on the cognitive search algorithm. Additionally, each result displayed by the search results interface 120 may present an excerpt from the summary table 110. For example, the excerpt from the summary table 110 may display a short narration of a medical symptom described in the summary table.

Each result displayed by the search results interface 120 may be selected by a user. Selecting a search result at the search results interface 120 may cause the user interface to display a corresponding summary table on the user interface. For example, the user interface may jump from page 3 to page 9 of the summary report to display the summary table 110 associated with the data corresponding to the selected search result in response to a user selecting a search result at the search result interface 120. Additionally, selecting a search result at the search results interface 120 may cause the user interface to highlight corresponding data at the summary table 110. For example, the user interface may highlight a medical symptom of interest at the summary table 110 associated with the data corresponding to the selected search result in response to a user selecting a search result at the search result interface 120. At least one search result displayed by the search result interface 120 may be organized in the same order as the summary tables. For example, certain results may be organized by the page number of the summary report where the summary table 110 may be found. Alternatively, or additionally, the search results may be organized by their relevancy to the query, the order of appearance of its corresponding summary table within the summary report, or the chronological order of when the corresponding record was created.

Each result displayed by the search results interface 120 may present data corresponding to the summary table 110. For example, the search results may emphasize matching words, similar words, or similar phrases in the search result interface 120 that appear in the corresponding summary table. The search results appearing within the search result interface 120 may have corresponding text highlighted in the summary table 110. Selecting a search result within the search result interface 120 may cause the corresponding text to be highlighted within the summary table 110. For example, a narrative of the summary may be highlighted as a result of a user selecting a search result within the search result interface 120. Additionally, selecting a search result within the search result interface 120 may cause the user interface within a different window pane to jump to the matching text within the set of summary tables. For example, if the user selects narration in the search result interface 120, at least a portion of the user interface may jump to page 8 of the summary report to display the relevant summary table. In another example, the user interface displaying the summary tables may create a bookmark at the relevant summary table, the bookmark causing the user interface to scroll several pages before arriving at the corresponding highlighted text.

The search result interface 120 may enable a user to quickly identify the most relevant information by scrolling through the search results using a scroll bar. Search result interface 120 may be user-interactive, enabling a user to reorder results, mark results, and save the results for later selection. The search result interface 120 may allow the user to control how much of the excerpt representative of the summary table is displayed. For example, the search result interface 120 may display a single sentence of the summary table 110 corresponding to the search result. A user may toggle between search results on the search result interface 120, causing the user interface to toggle between summary tables.

An Optical Character Recognition (“OCR”) may be performed on a set of records to generate the summary report including the summary table 110. The records may be searchable by performing the OCR. The data extracted by the OCR on the set of records may be placed into a particular technical file. For example, the extracted data may be organized into a JavaScript Object Notation (JSON) file. Alternatively, and/or additionally, the extracted data may be organized into any lightweight, text-based, human-readable, and text editor file. For example, an XML file, Wordpad text file, or a plain text file may be used. The JSON file and other text files may be used interchangeably. The set of records may be electronic or physical. For example, the set of records may be based on a scan of a PDF.

Based on the JSON file, various different procedures may be used to generate the summary reports. The JSON file may provide the structure to quickly call and organize the data for various presentation styles. The JSON file may enable the cognitive search function to build queries and deliver results. Additionally, the user interface may be built around the JSON file. For example, the user interface may appear to be searching, highlighting, and/or interacting with the electronic copies of what was scanned by displaying original copies or reformatted copies. But the user interface may be built based on the JSON files to provide a more responsive environment rather than waiting for the original pdf to load to present the summary records. In some instances, the user interface may be rendered and accessed in a browser in which the pages load up, viewed by a user, and the user may highlight, annotate, and export the information.

Once the image of that record is captured using the JSON files, a background search may be used to gather the information. Scripts may crawl through this JSON file and can recognize poorly illustrated characters. For example, the OCR may distinguish between characters between a comma, an apostrophe, or the letter “c” in a low-quality scan. A spellcheck may be performed on the extracted data in the JSON files. For example, the spell check must be thorough and aggressive for medical records to ensure correctly spelled medical terminology.

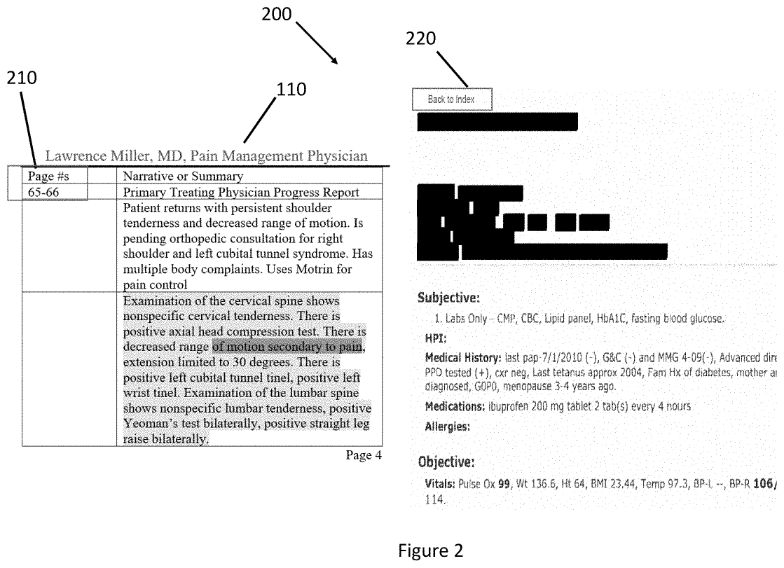

FIG. 2 depicts a user interface illustrating a record report hyperlinked to a record, in accordance with some example embodiments. The record report may be a summary report, the summary table 110, or any data structure representative of a record of a set of records. In some embodiments, the set of records may be placed at the end of the summary report.

The hyperlinked record reporting system 200 may generate various hyperlinks at the summary table 110 and the set of records. Each summary table 110 of the summary report may include hyperlinks to the set of records. The user interface may jump forward to the corresponding record in the set of records in response to a user selecting an advancing hyperlink 210 in the summary report. The user interface may also jump back to the corresponding hyperlink in the summary report after selecting a backtracking hyperlink 220 associated with the record of the set of records. For example, selecting advancing hyperlink 210 causes the user interface to jump forward to a record in the set of records on pages 65 and 66 with a single click. In another example, selecting backtracking hyperlink 220 causes the user interface to jump back to the corresponding summary table.

Generating the summary report may include generating an advancing hyperlink 210 for each summary table 110. The advancing hyperlink 210 associated with a summary table 110 connects the summary table 110 to a corresponding record of the set of records. That is, the advancing hyperlink 210 may be configured to cause the user interface to display the corresponding record associated with the summary table 110. For example, page numbers 65-66 in summary table 110 may be the advancing hyperlink 210 to the corresponding medical record on page 65 and 66 in the medical record. Additionally, generating the summary report includes generating a backtracking hyperlink 220 for each record of the set of records. The backtracking hyperlink 220 associated with each record of the set of records connects the record to the corresponding summary table. That is, the backtracking hyperlink 220 may be configured to cause the user interface to display the corresponding entry connected to a record of the set of records. In one example implementation, a graphical user interface link, shown as “Back to Index” link, in FIG. 2, may be the backtracking hyperlink 220 to the corresponding summary table in the record report. Additional hyperlinks in the summary reports may direct a user to a verbatim quotation found in the record. The summary table 110 may enable the user to drive to the location of the relevant information in the set of records.

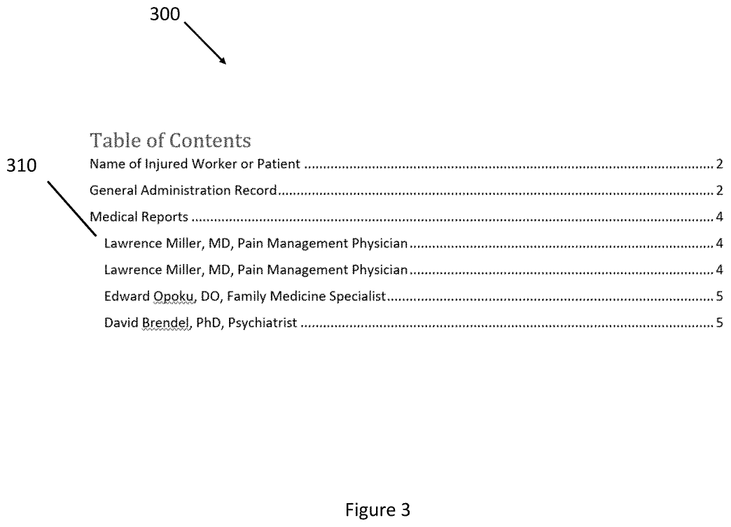

FIG. 3 depicts a user interface illustrating a table of contents hyperlinked to a record report, in accordance with some example embodiments. The hyperlinked table of contents 310 provide an overview of the summary tables in the summary report.

The hyperlinked table of contents user interface 300 may be generated by the record reporting system 100. The hyperlinked table of contents 310 enable the user to jump to the summary table 110 by selecting the hyperlink on the user interface. The hyperlinked table of contents 310 may include a series of hyperlinked page numbers corresponding to the summary tables. Additionally, the hyperlinked table of contents 310 may change the user interface to present the summary table 110 corresponding to an entry at the hyperlinked table of contents 310. Additionally, selecting a hyperlink at the summary table 110 may cause the user interface to jump back to the corresponding entry in the hyperlinked table of contents 310.

The hyperlinked table of contents 310 may be constructed based on the various header tabs displayed throughout the generated summary report. Alternatively, or additionally, the hyperlinked table of contents 310 may be constructed based on headers found within the set of records. Each entry of the hyperlinked table of contents 310 is linked to a header tab in the plurality of summary tables.

The order for which the table of contents 105 is organized may correspond to the set of records or the summary tables. For example, an entry for a first physician in the table of contents may be followed by an entry by a second physician to follow the order in which the physicians' reports are organized in the set of records. Alternatively, and/or additionally, the set of records and/or the summary tables may be reorganized by the table of contents such that the table of contents controls the order of the set of records.

The cognitive search engine (not shown in FIG. 3) may execute the query. The cognitive search engine enables users to cover expansive searches beyond the keyword, phrase, or language parameters entered into the query fields. For example, the user may search for lower back pain, and the cognitive search engine may return results for a variety of synonyms related to lower back pain, such as spinal injury, lower vertebra, or lateral posterior spinal injury. In another example, the cognitive search engine may simultaneously search for include left temporal lobe pain, prior surgical history, opioid use, and prescription abuse. The cognitive search engine, in some aspects, is configured to anticipate how a user might think and return instances that are related to the idea around the search. This feature, advantageously enables the cognitive search engine to gather pertinent results and reassures the user that a narrow search didn't miss relevant information. In some embodiments, the cognitive search engine relies on the hyperlinked summaries to generate search results.

The cognitive search engine may help construct the summary reports by crawling crawl through this JSON file. The summary table 110 may pull information verbatim from the JSON file. Alternatively, and/or additionally, the Cognitive search engine may interpret the information provided by the JSON file and create a summary table that rephrases complex concepts to succinct descriptions. Alternatively, and/or additionally, the summary table 110 may be generated by an AI-enhanced algorithm that extracts the most relevant portions from the JSON file and condenses information contained within the record. The cognitive search engine may identify information in the first set of records that is relevant in multiple summaries and incorporate the information into the various summaries.

A proximity search may enable the cognitive search engine to identify results that are proximate to certain keywords (or other words as determined by the fuzzy search). For example, the search engine may only return results that are within the same paragraph or within ten words of another keyword. In another example, the user may search for pain and have 1,000 hits. The user may determine she is only interested in “shoulder pain” so the system will return only results of the word “pain” within a certain proximity (e.g., ten words). Additional relevancy may be provided by searching shoulder pain within ten words of cortisone injections or shoulder pain within ten words of surgery.

The cognitive search engine may detect the level of medical care provided against the standards of care for a particular jurisdiction. For example, the cognitive search engine may compare the level of care rendered against a state's worker's compensation disability ratings guidelines. Additionally, the cognitive search engine may retrieve relevant information from the set of records to detect fraudulent care, a faked injury, fraudulent expenses, and/or the like. The cognitive search engine can draw comparisons between typical compensation for persons having a similar injury. The system can prevent an employee from billing fraudulent charges against the employer. For example, the system may make comparisons for a 45-year old man who has a right shoulder injury using the standards of the American College of Occupational Medicine Center. The standards may provide guidance that the man is entitled to $100,000 for a right shoulder fixation, two x-rays, six weeks of physical therapy, and being absent for work for four months.

The system may have voice-to-text software for audibly generated searches. Users may be able to log in to the software platform using voice commands for authentication and say an activation word. The activation word may enable the device to listen to a command or request from the user. The system may audibly return the results to the user or display the information to the user through the user interface. Voice searching allows users to multitask while using the software. The user may be able to interact with the software through voice commands instead of using a keyboard, mouse, touch screen, and/or the like.

The search query may be customized by the user through prebuilt search configurations. The user may also select universal prebuilt searches. The users may be able to further customize the universal prebuilt searches according to their needs. Alternatively, and/or additionally, the record reporting system 100 may have a set of selectable search configurations. These search configurations may be performed on a schedule. The system may highlight the most frequently used searches. The record reporting system 100 may generate a table indexing all of the previous searches. The records for each client may be indexed, enabling a user to scroll through the index and identify relevant records.

In addition to a search query option, the record reporting system 100 may include a medical search tab that may be used as a link to a National Institute of Health search online. The Medical search tab may automatically compare search results against the National Institute of Health so that there is a third party, neutral, evaluation of the procedures that are being done. Users may check their biases and/or assumptions against the best practices of the National Institute of Health.

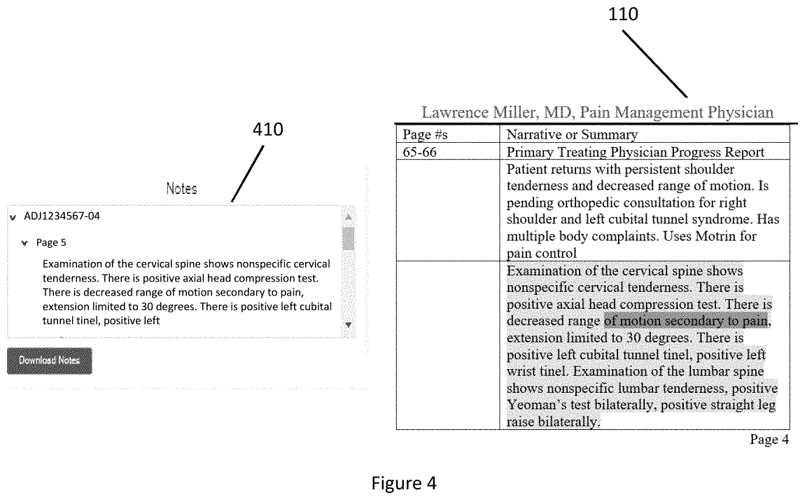

FIG. 4 depicts a user interface illustrating an annotation interface hyperlinked to the record report, in accordance with some example embodiments. An annotation interface 410 may be used to make notes corresponding to the summary table 110. The notes may be bookmarks, comments, features, files, and/or the like. The user may make notes within the user interface that are mapped to a particular summary table. For example, the case information from case prep, trial prep, claims management, or any other number of systems may be incorporated using the note system.

Rows, columns, texts, figures, and tables may be highlighted and saved into the note system associated with the annotation window 130. The note system maintains the notes and annotations in perfect record and page order as the summary report is transferred between users and systems. Notes may be downloaded into the reporting system by pulling the appropriate references from the Internet or an application. Additional notes may be pulled into the system or incorporated.

Hyperlinks may connect the summary table 110 to the annotation interface 410. A hyperlink associated with at least one summary table 110 connects the summary table 110 to a corresponding set of notes in the annotation interface 410. That is, the hyperlink may be configured to cause the annotation interface 410 to display the corresponding set of notes associated with the summary table 110. Additional hyperlinks in the summary reports may direct a user to a verbatim quotation found in the annotation interface 410. The summary table 110 may enable the user to drive to the location of the relevant information at the annotation interface 410.

Hyperlinks may connect the annotation interface 410 to the summary table 110. The hyperlink associated with at least one note at the annotation interface 410 connects the record to the corresponding summary table. That is, the hyperlink may be configured to cause the user interface to display the corresponding summary table connected to a note at the annotation interface 410. The user may select a result within the annotation interface 410, toggling the user interface to display the corresponding summary table.

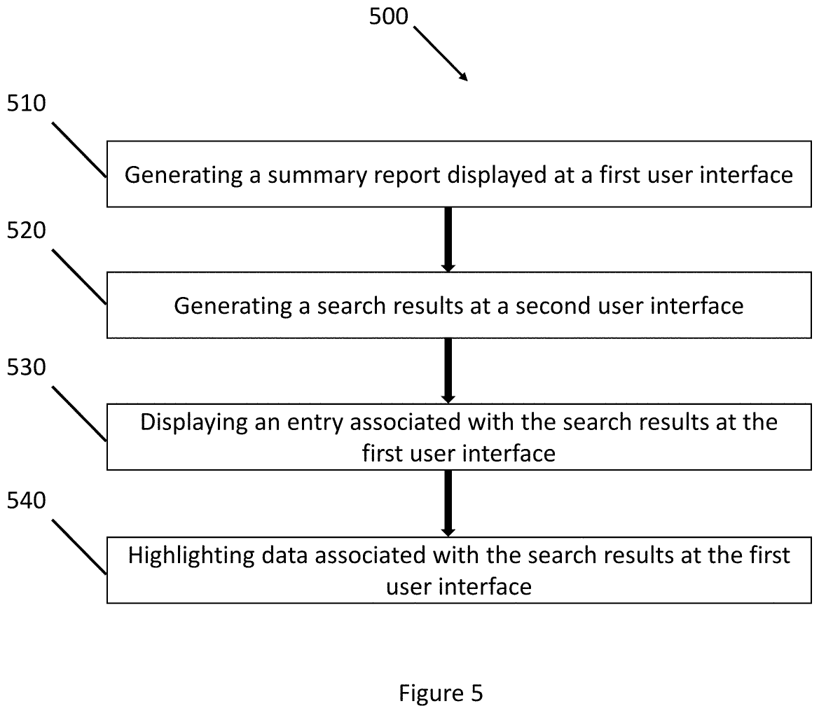

FIG. 5 depicts a flowchart illustrating a process for generating a user interface configured to display and highlight data corresponding to a search result, in accordance with some example embodiments. The record reporting flowchart process 500 may be supervised or carried out by the record reporting system 100. At 510, a summary report is generated based on a set of records. The summary report includes a plurality of entries with data representative of the set of records, and the summary report is displayed in a first user interface. At 520, a second user interface is generated that is configured to display a search result based on a query, the search result including data associated with the plurality of entries. At 530, at least an entry from among the plurality of entries associated with data corresponding to the selected search result is displayed at the first user interface in response to a user selection of the search result at the second user interface. At 540, the data corresponding to the selected search result is highlighted at the first interface in response to the user selection of the search result at the second user interface.

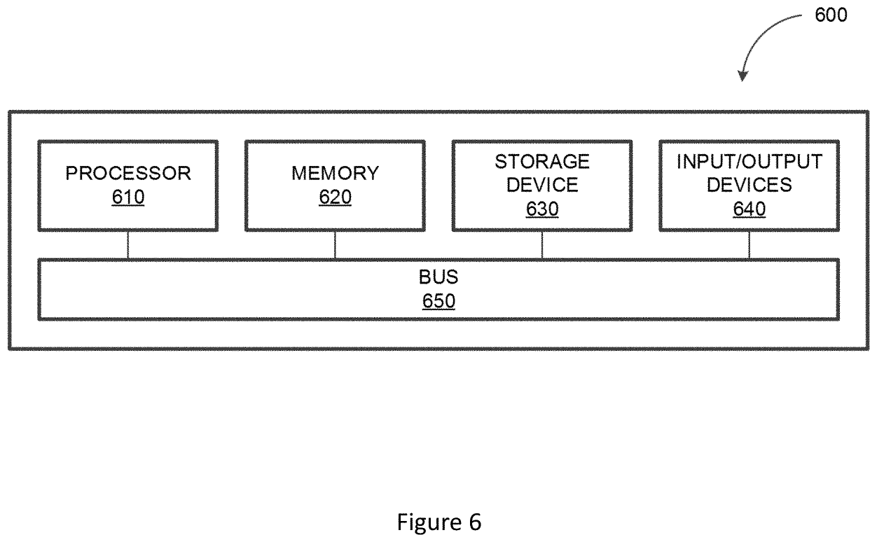

FIG. 6 depicts a block diagram of an example computing system, in accordance with some embodiments. Referring to FIGS. 1 through 6, the computing system 600 can be used to implement the record reporting system 100 and/or any components therein.

As shown in FIG. 6, the computing system 600 can include a processor 610, a memory 620, a storage device 630, and input/output devices 640. The processor 610, the memory 620, the storage device 630, and the input/output devices 640 can be interconnected via a system bus 650. The processor 610 is capable of processing instructions for execution within the computing system 600. Such executed instructions can implement one or more components of, for example, the record reporting system 100. In some example embodiments, the processor 610 can be a single-threaded processor. Alternatively or additionally, the processor 610 may be a multi-threaded processor. The processor 610 is capable of processing instructions stored in the memory 620 and/or on the storage device 630 to display graphical information for a user interface provided via the input/output device 640.

The memory 620 is a computer-readable medium such as volatile or non-volatile that stores information within the computing system 600. The memory 620 can store data structures representing configuration object databases, for example. The storage device 630 is capable of providing persistent storage for the computing system 600. The storage device 630 can be a floppy disk device, a hard disk device, an optical disk device, a tape device, a solid-state drive, and/or other suitable persistent storage means. The input/output device 640 provides input/output operations for the computing system 600. In some example embodiments, the input/output device 640 includes a keyboard and/or pointing device. In various implementations, the input/output device 640 includes a display unit for displaying graphical user interfaces.

According to some example embodiments, the input/output device 640 can provide input/output operations for a network device. For example, the input/output device 640 can include Ethernet ports or other networking ports to communicate with one or more wired and/or wireless networks (e.g., a local area network (LAN), a wide area network (WAN), the Internet).

In some example embodiments, the computing system 600 can be used to execute various interactive computer software applications that can be used for organization, analysis and/or storage of data in various formats. Alternatively, the computing system 600 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities (e.g., SAP Integrated Business Planning as an add-in for a spreadsheet and/or other type of program) or can be standalone computing items and/or functionalities. Upon activation within the applications, the functionalities can be used to generate the user interface provided via the input/output device 640. The user interface can be generated and presented to a user by the computing system 600 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program item, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

In the following description, for purposes of explanation, numerous specific details are set forth in order to provide a thorough understanding of the various embodiments. It should be understood that other embodiments may be utilized, and structural changes may be made without departing from the scope of the disclosed subject matter. Any combination of the following features and elements is contemplated to implement and practice the disclosure.

In the description, common or similar features may be designated by common reference numbers. As used herein, “exemplary” may indicate an example, an implementation, or an aspect, and should not be construed as limiting or as indicating a preference or a preferred implementation.

What is claimed is:

1. A system comprising:
at least one data processor; and
at least one memory storing instructions which, when executed by the at least one data processor, result in operations comprising:
generating a summary report based on a set of records, the summary report including a plurality of entries with data representative of the set of records, the summary report displayed in a first user interface;
generating a second user interface configured to display a search result based on a query, the search result including data associated with the plurality of entries;
in response to a user selection of the search result at the second user interface, displaying an entry from among the plurality of entries associated with data corresponding to the selected search result at the first user interface; and
in response to the user selection of the search result at the second user interface, highlighting the data corresponding to the selected search result displayed at the first user interface.

2. The system of claim 1, wherein generating the summary report includes generating a hyperlink for each of at least two entries of the plurality of entries, the hyperlink connecting each of the at least two entries of the plurality of entries to each of at least two corresponding records of the set of records, the hyperlink configured to instruct the first user interface to display each of the at least two corresponding records connected to the at least two entries of the plurality of entries.

3. The system of claim 2, wherein generating the summary report includes generating an additional hyperlink for each of at least two records of the set of records, the additional hyperlink connecting each of the at least two records of the set of records to each of at least two corresponding entries of the plurality of entries, the additional hyperlink configured to instruct the first user interface to display each of the at least two corresponding entries connected to the at least two records of the set of records.

4. The system of claim 1, wherein the generating the summary report further comprises:
storing text from an optical character recognition of the set of records into a Java Script Object Notification (JSON) file, the summary report generated based on the data stored in the JSON file.

5. The system of claim 4, wherein a cognitive search algorithm performs the query, the query being based on the JSON file, the cognitive search algorithm configured to return similar words and phrases as a keyword for conducting the query.

6. The system of claim 4, wherein the first user interface and the second user interface are generated based on the JSON file.

7. The system of claim 1, wherein the search result includes a narrative from the summary report.

8. The system of claim 1, further comprising:
in response to an additional user selection of an additional search result at the second user interface, displaying an additional entry of the plurality of entries associated with additional data corresponding to the additional search result at the first user interface; and
in response to the additional user selection of the additional search result at the second user interface, highlighting the additional data corresponding to the additional search result displayed at the first user interface.

9. The system of claim 1, wherein generating the summary report includes generating an annotation interface including comments, the annotation interface connected to the entry of the plurality of entries by a hyperlink, the hyperlink configured to instruct the first user interface to display the comments connected to the entry of the plurality of entries.

10. The system of claim 9, wherein in response to selecting the hyperlink, the comments connected to the entry of the plurality of entries are highlighted.

11. A computer-implemented method, comprising:
generating a summary report based on a set of records, the summary report including a plurality of entries with data representative of the set of records, the summary report displayed in a first user interface;
generating a second user interface configured to display a search result based on a query, the search result including data associated with the plurality of entries;
in response to a user selection of the search result at the second user interface, displaying an entry from among the plurality of entries associated with data corresponding to the selected search result at the first user interface; and
in response to the user selection of the search result at the second user interface, highlighting the data corresponding to the selected search result displayed at the first user interface.

12. The method of claim 11, wherein generating the summary report includes generating a hyperlink for each of at least two entries of the plurality of entries, the hyperlink connecting each of the at least two entries of the plurality of entries to each of at least two corresponding records of the set of records, the hyperlink configured to instruct the first user interface to display each of the at least two corresponding records connected to the at least two entries of the plurality of entries.

13. The method of claim 12, wherein generating the summary report includes generating an additional hyperlink for each of at least two records of the set of records, the additional hyperlink connecting each of the at least two records of the set of records to each of at least two corresponding entries of the plurality of entries, the additional hyperlink configured to instruct the first user interface to display each of the at least two corresponding entries connected to the at least two records of the set of records.

14. The method of claim 11, wherein the generating the summary report further comprises:
storing text from an optical character recognition of the set of records into a Java Script Object Notification (JSON) file, the summary report generated based on the data stored in the JSON file.

15. The method of claim 14, wherein a cognitive search algorithm performs the query, the query being based on the JSON file, the cognitive search algorithm configured to return similar words and phrases as a keyword for conducting the query.

16. The method of claim 14, wherein the first user interface and the second user interface are generated based on the JSON file.

17. The method of claim 11, wherein the search result includes a narrative from the summary report.

18. The method of claim 11, further comprising:
in response to an additional user selection of an additional search result at the second user interface, displaying an additional entry of the plurality of entries associated with additional data corresponding to the additional search result at the first user interface; and
in response to the additional user selection of the additional search result at the second user interface, highlighting the additional data corresponding to the additional search result displayed at the first user interface.

19. The method of claim 11, wherein generating the summary report includes generating an annotation interface including comments, the annotation interface connected to the entry of the plurality of entries by a hyperlink, the hyperlink configured to instruct the first user interface to display the comments connected to the entry of the plurality of entries.

20. A non-transitory computer-readable medium comprising instructions which, when executed by at least one processor, cause operations comprising:
generating a summary report based on a set of records, the summary report including a plurality of entries with data representative of the set of records, the summary report displayed in a first user interface;
generating a second user interface configured to display a search result based on a query, the search result including data associated with the plurality of entries;
in response to a user selection of the search result at the second user interface, displaying an entry from among the plurality of entries associated with data corresponding to the selected search result at the first user interface; and
in response to the user selection of the search result at the second user interface, highlighting the data corresponding to the selected search result displayed at the first user interface.
